(19) United States
(12) Patent Application Publication
(10) Pub. No.: US 2004/0170660 A1
(43) Pub. Date: Sep. 2, 2004

(54) Stabilization of cosmetic or dermatological formulations comprising repellent active compounds

(75) Inventors: Volker Wendel, (US); Anja Goppel, (US); Anja Suckert, (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Beiersdorf AG

(21) Appl. No.: 10/789,711

(22) Filed: Feb. 27, 2004

Related U.S. Application Data
(63) Continuation of application No. PCT/EP02/09543, filed on Aug. 27, 2002.

(30) Foreign Application Priority Data
Aug. 29, 2001 (DE) 101 41 471.4

(51) Int. Cl. A01N 25/00

(52) U.S. Cl. 424/405

(57) ABSTRACT

Cosmetic or dermatological formulations having at least one repellent active compound, have the stability of the repellant active compound stabilized, allowing for higher concentrations of repellant active compound, through the addition of at least one dialkyl naphthalate having the structural formula

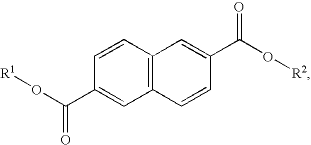

wherein R¹ and R² independently of one another are selected from the group consisting of branched and unbranched alkyl groups having 6 to 24 carbon atoms.

### CROSS-REFERENCE TO RELATED APPLICATIONS

This is a continuation application of PCT/EP02/09543, filed Aug. 27, 2002, which is incorporated herein by reference in its entirety, and also claims the benefit of German Priority Application No. 101 41 471.4, filed Aug. 29, 2001.

### FIELD OF THE INVENTION

The present invention relates to the use of alkyl naphthalates for increasing the stability of cosmetic or dermatological formulations comprising insect repellents. The present invention preferably relates to cosmetic or dermatological formulations for targeted prevention of insect bites, in which such active compounds can be stored in a stable manner over a long period of time and which are a good means of transport for these active compounds.

### BACKGROUND OF THE INVENTION

Insect repellents (insectifuges, anti-insect agents, repellent substances, repellents) are preparations which are used externally to repel and/or drive away insects and also ticks and mites and are intended to prevent these from becoming active on the skin. Insect repellents are intended to protect the skin from trouble from blood-sucking or biting insects and other parasites and/or pests by repelling these before they fly on to the skin, so that stings or bites do not occur. The agents accordingly act not as contact poisons, but only as repellents, since they do not kill the animals but only drive them away.

In the context of the present invention, the term “insect repellent” accordingly is not only to be understood as meaning formulations which are active against insects. Rather, the statements in the following of course also apply to those preparations which repel or drive away other blood-sucking or biting parasites, even if this is not mentioned in the individual case.

Even from primeval times, humans have been plagued by stinging or biting insects or other parasites. Mankind's need for insect repellents is accordingly old. A method known from early history for making it unattractive or unpleasant to pestilent or harmful insects to stay close to humans is the lighting of fires with aromatically or pungently smelling herbage or wood and heavy generation of smoke. Treatment of skin with strongly smelling substances to repel insects has also already been known since ancient times. At about the turn of the last century, a number of naturally occurring essential oils were being used as insect repellents, thus, for example, aniseed oil, bergamot oil, birchwood tar, camphor, citronella oil, eucalyptus oil, geranium oil, pine oil, coconut oil, lavender oil, nutmeg oil, clove oil, orange blossom oil, peppermint oil, pennyroyal oil, pyrethrum, thyme oil and cinnamon oil.

Because of their predominantly inadequate activity, in spite of an intensive smell, and their sometimes lack of tolerability in higher concentrations, these substances have largely been displaced in current insect repellents by synthetic substances having a better action. These are predominantly high-boiling liquids or low-melting crystalline substances which evaporate slowly at room temperature. Most repellent active compounds belong to the substance classes of amides, alcohols, esters and ethers.

Repellent active compounds should meet certain conditions. They should not vaporize too rapidly and should not penetrate into the skin. They should have neither a primarily irritating nor a sensitizing action on the skin, and moreover should be non-toxic. Their activity must be retained even under the action of skin fluid and/or UV radiation.

Of the approx. 15 active compounds currently often employed in insect repellents, N,N-diethyl-3-methylbenzamide (DEET), which is distinguished by the following structural formula

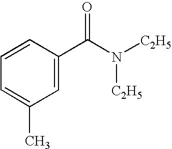

is described as the best all-round repellent. It has a repellent action against mosquitoes, horse-flies, sand-flies, ticks, biting flies, mites, fleas and bugs, the duration of action—as with all repellent active compounds—against the various species varying in length. Commercially available DEET preparations, for example, are active against midges for approx. 6 to 8 hours, but against ticks for only approx. 2 to 4 hours.

Another common repellent active compound is 3-(N-n-butyl-N-acetyl-amino)propionic acid ethyl ester (also called repellent 3535), which is distinguished by the following structural formula

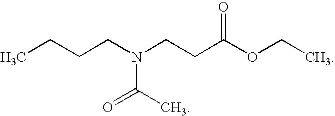

Repellent 3535 is active against mosquitoes (Aedes aegypti, Anopheles albimanus), tsetse flies (Glossinae) and horse-flies (Tabanidae).

Dimethyl phthalate (Palatinol M, DMP)

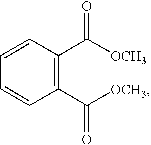

furthermore is a common compound which is active against mosquitoes (in particular Aedes and Anopheles species), lice, ticks and mites, although it is chiefly used in combination with further repellent active compounds.

Stings or bites from insects and other parasites usually at most lead to urtication, redness and itching and in isolated cases to usually harmless infections. However, insects, in particular midges, can also be transmitters of parasitic and viral infections (such as e.g. malaria, yellow fever or dengue fever). There are in total e.g. no fewer than 3,000 different species of mosquito, of which about 100 can spread epidemics. Repelling or driving away these insects therefore also serves in particular as protection from such infections.

Insect repellents are available in the form of solutions, gels, sticks, roll-ons, pump sprays and aerosol sprays, solutions and sprays forming the majority of the commercially available products. These two product forms are usually based on alcoholic or aqueous-alcoholic solutions with the addition of oiling substances and mild perfumes. Other formulation forms, such as, in particular, emulsions, creams, ointments and the like, are indeed in principle conceivable, but in some cases are difficult to formulate in a stable manner.

The duration of action of the preparations usually increases with the concentration of the insect-repelling active compound in the finished product, which as a rule is between 20 and 70 wt. %. It furthermore depends on the layer thickness on application and on the intensity of perspiration and the external temperature.

A disadvantage of emulsions in particular, however, is often their lack of stability towards relatively high repellent active compound concentrations, which manifests itself in phase separation.

### SUMMARY OF THE INVENTION

It was therefore an object of the present invention to discover cosmetic or dermatological formulations, in particular emulsions, which are stable towards increased repellent active compound concentrations.

It was surprising and not foreseeable to the expert that cosmetic and dermatological formulations having at least one repellent active compound, characterized in that they comprise at least one dialkyl naphthalate which is distinguished by the structural formula

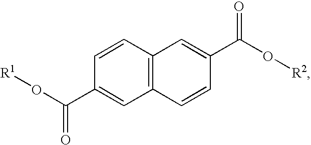

wherein R¹ and R² independently of one another are chosen from the group consisting of branched and unbranched alkyl groups having 6 to 24 carbon atoms, remedy the disadvantages of the prior art.

The formulations in the context of the present invention can preferably additionally comprise, in addition to one or more oily phases, one or more aqueous phases and can be, for example, in the form of W/O, O/W, W/O/W or O/W/O emulsions. Such formulations can preferably also be a microemulsion, a solid emulsions (i.e. an emulsion which is stabilized by solids, e.g. a Pickering emulsion), a sprayable emulsion or a hydrodispersion.

### DETAILED DESCRIPTION OF THE PREFERRED EMBODIMENTS

The formulations according to the invention are in every aspect entirely satisfactory preparations which are not restricted to a limited choice of raw materials. Accordingly, they are very particularly suitable for use as a base for formulation forms with diverse intended uses. The formulations according to the invention show very good sensorial and cosmetic properties, such as, for example, the ability to be spread on the skin or the capacity for absorption into the skin, and are furthermore distinguished by a very good active compound effectiveness with simultaneously outstanding skin care data.

It had not been foreseeable to the expert that the use of alkyl naphthalates would provide better stabilization of cosmetic or dermatological formulations comprising at least one repellent active compound against decomposition.

The invention therefore also relates to the use of at least one dialkyl naphthalate which is distinguished by the structural formula

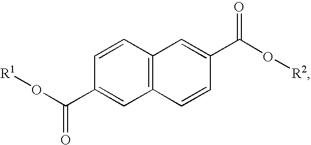

wherein R¹ and R² independently of one another are chosen from the group consisting of branched and unbranched alkyl groups having 6 to 24 carbon atoms, for for increasing the stability of cosmetic or dermatological formulations comprising at least one repellent active compound.

Particularly advantageous repellent active compounds in the context of the present invention are the abovementioned active compounds N,N-diethyl-3-methylbenzamide, 3-(N-n-butyl-N-acetyl-amino)propionic acid ethyl ester and dimethyl phthalate.

The repellent active compounds listed below are furthermore preferred according to the invention:

| | | | Activity |
|---|---|---|---|
| | | | (literature and |
| Chemical | | | manufacturer's |
| name | Trade name | Structure | data) |
| Butopyronoxyl | Indalone | 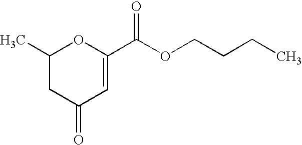 | biting insects¹ |
| 2,3;4,5-Bis- (2-butylene)- tetrahydro-2- furaldehyde | MGK- Repellent 11 | 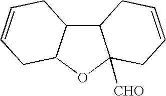 | cockroaches and biting insects¹ |
| N,N-Caprylic acid diethylamide | Repellent 790 | 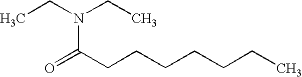 | cockroaches, mosquitoes, house flies, horse-flies, ants, arachnids |
| o-Chloro- N,N-diethyl- benzamide in a mixture with N,N-diethyl- benzamide | Kik- Repellent | 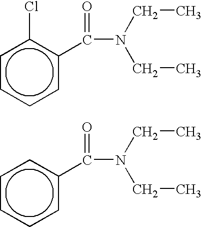 | mosquitoes, horse-flies, fleas, bugs, ticks, flies, lice |
| Dimethyl carbate | Dimalone | 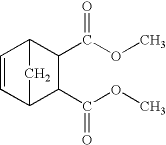 | mosquitoes, in particular Aedes species¹ |
| Di-n-propyl isocincho- meronate | MGK- Repellent 326 | 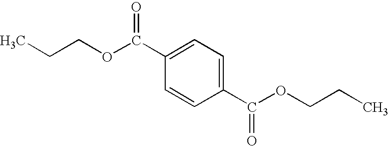 | house fly, bush fly¹ |
| 2- Ethylhexane- 1,3-diol | Rutgers 612 | 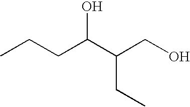 | mosquitoes, horse-flies, flies, fleas, mites¹ |
| N-Octyl-bi- cyclo- heptenedi- carboximide | MGK 264 insecticide synergist | 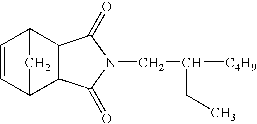 | synergist² |
| Piperonyl but- oxide | PBO | 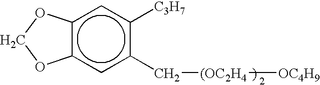 | synergist² |

¹chiefly in a mixture or combination with other repellents
²acts as a synergist in various repellents

It is preferable according to the invention to choose the content of the repellent active compound(s) (one or more compounds) in the cosmetic or dermatological compositions from the range of 1 to 70 wt. %, in particular 1 to 50 wt. %, in each case based on the total weight of the composition.

Dialkyl naphthalates for which R¹ and/or R² represent branched alkyl groups having 6 to 10 carbon atoms are advantageous in the context of the present invention. Diethylhexyl naphthalate, which is obtainable, for example, under the trade name Hallbrite TQ™ from CP Hall or Corapan TQ™ from H&R, is very particularly preferred in the context of the present invention.

Cosmetic or dermatological formulations advantageously comprise, according to the invention, 0.001 to 20 wt. %, preferably 0.01 to 15 wt. %, very particularly preferably 3 to 10 wt. % of one or more dialkyl naphthalates.

The cosmetic or dermatological formulations according to the invention can be of a conventional composition and can serve as cosmetic or dermatological protection from light, and furthermore for treatment, care and cleansing of the skin and/or hair and as a make-up product in decorative cosmetics.

According to their make-up, cosmetic or topical dermatological compositions in the context of the present invention can be used, for example, as skin protection cream, cleansing milk, day or night cream etc. It may be possible and advantageous to use the compositions according to the invention as a base for pharmaceutical formulations.

For use, the cosmetic and dermatological formulations are applied to the skin and/or the hair in a sufficient amount in the conventional manner for cosmetics.

The cosmetic and dermatological formulations according to the invention can comprise cosmetics auxiliaries such as are conventionally used in such formulations, e.g. preservatives, preservation aids, bactericides, perfumes, substances for preventing foaming, dyestuffs, pigments which have a coloring action, thickeners, moisturizing and/or moisture-retaining substances, fillers which improve the sensation on the skin, fats, oils, waxes or other conventional constituents of a cosmetic or dermatological formulations, such as alcohols, polyols, polymers, foam stabilizers, electrolytes, organic solvents or silicone derivatives.

Advantageous preservatives in the context of the present invention are, for example, agents which split off formaldehyde (such as e.g. DMDM hydantoin, which is obtainable, for example, under the trade name Glydant™ from Lonza), iodopropyl butyl carbamates (e.g. those obtainable under the trade names Glycacil-L, Glycacil-S from Lonza and/or Dekaben LMB from Jan Dekker), parabens (i.e. p-hydroxybenzoic acid alkyl esters, such as methyl, ethyl, propyl and/or butyl paraben), phenoxyethanol, ethanol, benzoic acid and many of the like. The preservation system furthermore advantageously also conventionally comprises, according to the invention, preservation aids, such as, for example, octoxyglycerol, glycine soya etc.

Particularly advantageous formulations are furthermore obtained if antioxidants are employed as additives or active compounds. According to the invention, the formulations advantageously comprise one or more antioxidants. All the antioxidants which are suitable or usual for cosmetic and/or dermatological uses can be used as antioxidants, which are favorable but nevertheless optionally to be used.

The amount of antioxidants (one or more compounds) in the formulations is preferably 0.001 to 30 wt. %, particularly preferably 0.05 to 20 wt. %, in particular 0.1 to 10 wt. %, based on the total weight of the formulation.

If vitamin E and/or derivatives thereof is/are the antioxidant(s), it is advantageous to choose the particular concentration thereof from the range of 0.001 to 10 wt. %, based on the total weight of the formulation.

If vitamin A or vitamin A derivatives or carotenes or derivatives thereof is/are the antioxidant(s), it is advantageous to choose the particular concentrations thereof from the range of 0.001 to 10 wt. %, based on the total weight of the formulation.

It is particularly advantageous if the cosmetic formulations according to the present invention comprise further cosmetic or dermatological active compounds, antioxidants which can protect the skin from oxidative exposure being preferred active compounds.

Advantageous further active compounds are naturally occurring active compounds and/or derivatives thereof, such as e.g. ubiquinones, retinoids, carotenoids, creatine, taurine and/or β-alanine.

Recipes according to the invention which e.g. comprise known antiwrinkling active compounds, such as flavone glycosides (in particular α-glycosylrutin), coenzyme Q10, vitamin E and/or derivatives and the like, are particularly advantageously suitable for the prophylaxis and treatment of cosmetic or dermatological skin changes, such as occur e.g. during ageing of the skin (such as, for example, dryness, roughness and development of dryness wrinkles, itching, reduced re-oiling (e.g. after washing), visible dilations of vessels (telangiectasis, cuperosis), flaccidity and the development of folds and wrinkles, local hyper-, hypo- and dyspigmentations (e.g. senile keratosis), increased susceptibility to mechanical stress (e.g. to chapping) and the like). They are moreover advantageously suitable against the appearance of dry or rough skin.

The aqueous phase of the formulations according to the invention can advantageously comprise conventional cosmetics auxiliaries, such as, for example, alcohols, in particular those of low C number, preferably ethanol and/or isopropanol, diols or polyols of low C number and ethers thereof, preferably propylene glycol, glycerol, ethylene glycol, ethylene glycol monoethyl or monobutyl ether, propylene glycol monomethyl, monoethyl or monobutyl ether, diethylene glycol monomethyl or monoethyl ether and analogous products, polymers, foam stabilizers, electrolytes and, in particular, one or more thickeners, which can advantageously be chosen from the group consisting of silicon dioxide, aluminum silicates, polysaccharides and derivatives thereof, e.g. hyaluronic acid, xanthan gum, hydroxypropylmethylcellulose, particularly advantageously from the group consisting of polyacrylates, preferably a polyacrylate from the group consisting of so-called Carbopols, for example Carbopols of the types 980, 981, 1382, 2984, 5984, in each case individually or in combination. Moisturizers can also preferably be used.

Substances or substance mixtures which impart to cosmetic or dermatological formulations, after application to or spreading on the surface of the skin, the property of reducing the release of moisture from the horny layer (also called transepidermal water loss (TEWL)) and/or of positively influencing hydration of the horny layer are called moisturizers.

Advantageous moisturizers in the context of the present invention are, for example, glycerol, lactic acid and/or lactates, in particular sodium lactate, butylene glycol, propylene glycol, biosaccaride gum-1, glycine soya, ethylhexyloxyglycerol, pyrrolidonecarboxylic acid and urea. It is furthermore in particular of advantage to use polymeric moisturizers from the group consisting of polysaccharides which are water-soluble and/or are swellable in water and/or can be gelled with the aid of water. Hyaluronic acid, chitosan and/or a fucose-rich polysaccharide which is filed in Chemical Abstracts under registration number 178463-23-5 and is obtainable e.g. under the name Fucogel®1000 from the company SOLABIA S.A. are, for example, particularly advantageous.

The cosmetic or dermatological formulations according to the invention can furthermore advantageously, although not necessarily, comprise fillers, which e.g. further improve the sensorial and cosmetic properties of the formulations and, for example, cause or intensify a velvety or silky sensation on the skin. Advantageous fillers in the context of the present invention are starch and starch derivatives (such as e.g. tapioca starch, distarch phosphate, aluminum or sodium starch octenyl succinate and the like), pigments which have neither a chiefly UV filter nor a coloring action (such as e.g. boron nitride etc.) and/or Aerosils® (CAS no. 7631-86-9).

The oily phase of the formulations according to the invention is advantageously chosen from the group consisting of polar oils, for example from the group consisting of lecithins and fatty acid triglycerides, namely the triglycerol esters of saturated and/or unsaturated, branched and/or unbranched alkanecarboxylic acids of a chain length of 8 to 24, in particular 12 to 18 C atoms. The fatty acid triglycerides can advantageously be chosen, for example, from the group consisting of synthetic, semi-synthetic and naturally occurring oils, such as e.g. coconut glyceride, olive oil, sunflower oil, soya oil, groundnut oil, rape oil, almond oil, palm oil, coconut oil, castor oil, wheat germ oil, grape seed oil, thistle oil, evening primrose oil, macadamia nut oil and many of the like.

Naturally occurring waxes of animal and plant origin e.g. are furthermore advantageous according to the invention, such as, for example, beeswax and other insect waxes and berry wax, shea butter and/or lanolin (wool wax).

Further advantageous polar oil components can furthermore be chosen in the context of the present invention from the group consisting of esters of saturated and/or unsaturated, branched and/or unbranched alkanecarboxylic acids of a chain length of 3 to 30 C atoms and saturated and/or unsaturated, branched and/or unbranched alcohols of a chain length of 3 to 30 C atoms and from the group consisting of esters of aromatic carboxylic acids and saturated and/or unsaturated, branched and/or unbranched alcohols of a chain length of 3 to 30 C atoms. Such ester oils can then advantageously be chosen from the group consisting of octyl palmitate, octyl cocoate, octyl isostearate, octyl dodeceylmyristate, octyldodecanol, cetearyl isononanoate, isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexyldecyl stearate, 2-octyidodecyl palmitate, stearyl heptanoate, oleyl oleate, oleyl erucate, erucyl oleate, erucyl erucate, tridecyl stearate, tridecyl trimellitate, and synthetic, semi-synthetic and naturally occurring mixtures of such esters, such as e.g. jojoba oil.

The oily phase can furthermore advantageously be chosen from the group consisting of dialkyl ethers and dialkyl carbonates, and advantageous compounds are e.g. dicaprylyl ether (Cetiol OE) and/or dicaprylyl carbonate, for example that obtainable under the trade name Cetiol CC from Cognis.

The oil component or components can be selected from the group consisting of isoeicosane, neopentylglycol diheptanoate, propylene glycol dicaprylate/dicaprate, caprylic/capric/diglyceryl succinate, butylene glycol dicaprylate/dicaprate, C₁₂₋₁₃-alkyl lactate, di-C₁₂₋₁₃-alkyl tartrate, triisostearin, dipentaerythrityl hexacaprylate/hexacaprate, propylene glycol monoisostearate, tricaprylin, dimethyl isosorbide. It is particularly advantageous if the oily phase of the formulations according to the invention has a content of C₁₂₋₁₅-alkyl benzoate, or consists entirely of this.

Advantageous oil components are furthermore e.g. butyloctyl salicylate (for example that obtainable under the trade name Hallbrite BHB from CP Hall), hexadecyl benzoate and butyloctyl benzoate and mixtures thereof (Hallstar AB).

Any desired blends of such oil and wax components are also advantageously to be employed in the context of the present invention.

The oily phase can furthermore likewise advantageously also comprise non-polar oils, for example those which are chosen from the group consisting of branched and unbranched hydrocarbons and hydrocarbon waxes, in particular mineral oil, Vaseline (petrolatum), paraffin oil, squalane and squalene, polyolefins, hydrogenated polyisobutenes and isohexadecane. Among the polyolefins, polydecenes are the preferred substances.

The oily phase can furthermore advantageously have a content of cyclic or linear silicone oils or consist entirely of such oils, although it is preferable to use an additional content of other oily phase components in addition to the silicone oil or the silicone oils.

Silicone oils are high molecular weight synthetic polymeric compounds in which silicon atoms are linked in a chain- or net-like manner via oxygen atoms and the remaining valencies of the silicon are satisfied by hydrocarbon radicals (usually methyl groups, less frequently ethyl, propyl, phenyl groups and the like). The silicone oils are systematically called polyorganosiloxanes. The methyl-substituted polyorganosiloxanes, which represent the most important compounds of this group in terms of amount and are distinguished by the following structural formula

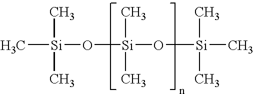

are also called polydimethylsiloxane or dimethicone (INCI). There are dimethicones in various chain lengths or with various molecular weights.

Particularly advantageous polyorganosiloxanes in the context of the present invention are, for example, dimethylpolysiloxanes [poly(dimethylsiloxane)], which are obtainable, for example, under the trade names Abil 10 to 10 000 from Th. Goldschmidt. Phenylmethylpolysiloxanes (INCI: phenyl dimethicone, phenyl trimethicone), cyclic silicones (octamethylcyclotetrasiloxane or decamethylcyclopentasiloxane), which according to INCI are also called cyclomethicones, amino-modified silicones (INCI: amodimethicones) and silicone waxes, e.g. polysiloxane/polyalkylene copolymers (INCI: stearyl dimethicone and cetyl dimethicone) and dialkoxydimethylpolysiloxanes (stearoxy dimethicone and behenoxy stearyl dimethicone) which are obtainable as various Abil wax types from Th. Goldschmidt, are furthermore advantageous. However, other silicone oils are also advantageously to be used in the context of the present invention, for example cetyldimethicone, hexamethylcyclotrisiloxane, polydimethylsiloxane, poly(methylphenylsiloxane).

It is also advantageous in the context of the present invention to compile cosmetic and dermatological formulations of which the main purpose is not protection from sunlight but which nevertheless comprise a content of further UV protection substances. Thus e.g. UV-A or UV-B filter substances are usually incorporated into day creams or make-up products. UV protection substances, like antioxidants and, if desired, preservatives, also represent an effective protection of the formulations themselves against decay. Cosmetic and dermatological formulations which are in the form of a sunscreen composition are furthermore favorable.

The formulations in the context of the present invention accordingly preferably comprise at least one further UV-A, UV-B and/or broad-band filter substance. The formulations can, although not necessarily, optionally also comprise one or more organic and/or inorganic pigments as UV filter substances, which can be present in the aqueous and/or the oily phase.

The formulations according to the invention can furthermore advantageously also be in the form of so-called oil-free cosmetic or dermatological emulsions which comprise an aqueous phase and at least one UV filter substance which is liquid at room temperature and/or one or more silicone derivatives as a further phase. Oil-free formulations in the context of the present invention can advantageously also comprise further lipophilic components—such as, for example, lipophilic active compounds.

UV filter substances which are liquid at room temperature and are particularly advantageous in the context of the present invention are homomenthyl salicylate (INCI: homosalate), 2-ethylhexyl 2-cyano-3,3-diphenylacrylate (INCI: octocrylene), 2-ethyl-hexyl 2-hydroxybenzoate (2-ethylhexyl salicylate, octyl salicylate, INCI: octyl salicylate) and esters of cinnamic acid, preferably 4-methoxycinnamic acid (2-ethylhexyl) ester (2-ethylhexyl 4-methoxycinnamate, INCI: octyl methoxycinnamate) and 4-meth-oxycinnamic acid isopentyl ester (isopentyl 4-methoxycinnamate, INCI: isoamyl p-meth-oxycinnamate).

Preferred inorganic pigments are metal oxides and/or other metal compounds which are sparingly soluble or insoluble in water, in particular oxides of titanium (TiO₂), zinc (ZnO), iron (e.g. Fe₂O₃), zirconium (ZrO₂), silicon (SiO₂), manganese (e.g. MnO), aluminum (AI₂O₃), cerium (e.g. Ce₂O₃), mixed oxides of the corresponding metals and blends of such oxides as well as barium sulphate (BaSO₄).

In the context of the present invention, the pigments can advantageously also be used in the form of commercially obtainable oily or aqueous predispersions. Dispersing auxiliaries and/or solubilization mediators can advantageously be added to these predispersions.

According to the invention, the pigments can advantageously be treated on the surface (“coated”), whereby, for example, a hydrophilic, amphiphilic or hydrophobic character is to be formed or retained. This surface treatment can comprise providing the pigments with a thin hydrophilic and/or hydrophobic inorganic and/or organic layer by processes known per se. The various surface coatings can also comprise water in the context of the present invention.

Inorganic surface coatings in the context of the present invention can comprise aluminum oxide (Al₂O₃), aluminum hydroxide Al(OH)₃, or aluminum oxide hydrate (also: alumina, CAS no.: 1333-84-2), sodium hexametaphosphate (NaPO₃)₆, sodium metaphosphate (NaPO₃)ₙ, silicon dioxide (SiO₂) (also: silica, CAS no.: 7631-86-9), or iron oxide (Fe₂O₃). These inorganic surface coatings can occur by themselves, in combination and/or in combination with organic coating materials.

Organic surface coatings in the context of the present invention can comprise plant or animal aluminum stearate, plant or animal stearic acid, lauric acid, dimethylpolysiloxane (also: dimethicone), methylpolysiloxane (methicone), simethicone (a mixture of dimethylpolysiloxane with an average chain length of 200 to 350 dimethyl-siloxane units and silica gel) or algic acid. These organic surface coatings can occur by themselves, in combination and/or in combination with inorganic coating materials.

Zinc oxide particles and predispersions of zinc oxide particles which are suitable according to the invention are obtainable under the following trade names from the companies listed:

| Trade name | Coating | Manufacturer |
|---|---|---|
| Z-Cote HP1 | 2% dimethicone | BASF |
| Z-Cote | / | BASF |
| ZnO NDM | 5% dimethicone | H&R |

Suitable titanium dioxide particles and predispersions of titanium dioxide particles are obtainable under the following trade names from the companies listed:

| Trade name | Coating | Manufacturer |
|---|---|---|
| MT-100TV | Aluminum hydroxide/ | Tayca |
| | stearic acid | Corporation |
| MT-100Z | Aluminum hydroxide/ | Tayca |
| | stearic acid | Corporation |
| Eusolex T-2000 | Alumina/simethicone | Merck KgaA |
| Titanium dioxide | Octyltrimethylsilane | Degussa |
| T805 | | |
| (Uvinul TiO₂) | | |
| Tioveil AQ 10PG | Alumina/silica | Solaveil/ |
| | | Uniquema |

Latex particles are further advantageous pigments. Latex particles which are advantageous according to the invention are those described in the following specifications: U.S. Pat. No. 5,663,213 and EP 0 761 201. Particularly advantageous latex particles are those which are formed from water and styrene/acrylate copolymers and are obtainable e.g. under the trade name “Alliance SunSphere” from Rohm & Haas.

Advantageous UV-A filter substances in the context of the present invention are dibenzoylmethane derivatives, in particular 4-(tert-butyl)-4′-methoxydibenzoylmethane (CAS no. 70356-09-1), which is sold by Givaudan under the trademark Parsol® 1789 and by Merck under the trade name Eusolex® 9020.

Advantageous further UV filter substances in the context of the present invention are sulfonated, water-soluble UV filters, such as e.g.

phenylene-1,4-bis-(2-benzimidazyl)-3,3′-5,5′-tetrasulfonic acid and its salts, in particular the corresponding sodium, potassium or triethanolammonium salts, in particular phenylene-1,4-bis-(2-benzimidazyl)-3,3′-5,5′-tetrasulfonic acid bis-sodium salt with the INCI name bisimidazylate (CAS no.: 180898-37-7), which is obtainable, for example, under the trade name Neo Heliopan AP from Haarmann & Reimer;

salts of 2-phenylbenzimidazole-5-sulfonic acid, such as its sodium, potassium or its triethanolammonium salt, and the sulfonic acid itself with the INCI name phenylbenzimidazole sulfonic acid (CAS no. 27503-81-7), which is obtainable, for example, under the trade name Eusolex 232 from Merck or under Neo Heliopan Hydro from Haarmann & Reimer;

1,4-di(2-oxo-10-sulfo-3-bornylidenemethyl)-benzene (also: 3,3′-(1,4-phenylenedimethylene)-bis-(7,7-dimethyl-2-oxo-bicyclo-[2.2.1]hept-1-ylmethane sulfonic acid) and salts thereof (in particular the corresponding 10-sulfato compounds, in particular the corresponding sodium, potassium or triethanolammonium salt), which is also called benzene-1,4-di(2-oxo-3-bornylidenemethyl-10-sulfonic acid). Benzene-1,4-di(2-oxo-3-bornylidenemethyl-10-sulfonic acid) has the INCI name terephthalidene dicamphor sulfonic acid (CAS no.: 90457-82-2) and is obtainable, for example, under the trade name Mexoryl SX from Chimex;

sulfonic acid derivatives of 3-benzylidenecamphor, such as e.g. 4-(2-oxo-3-bornylidenemethyl)benzenesulfonic acid, 2-methyl-5-(2-oxo-3-bornylidenemethyl)-sulfonic acid and salts thereof.

Advantageous UV filter substances in the context of the present invention are furthermore so-called broad-band filters, i.e. filter substances which absorb both UV-A and UV-B radiation.

Advantageous broad-band filters or UV-B filter substances are, for example, triazine derivatives, such as e.g.

2,4-bis-{[4-(2-ethyl-hexyloxy)-2-hydroxy]-phenyl}-6-(4-methoxyphenyl)-1,3,5-triazine (INCI: methylene bis-benzotriazolemethylbutylphenol), which is obtainable under the trade name Tinosorb® S from CIBA-Chemikalien GmbH;

dioctylbutylamidotriazone (INCI: diethylhexylbutamidotriazone), which is obtainable under the trade name UVASORB HEB from Sigma 3V;

4,4′,4″-(1,3,5-triazin-2,4,6-triyltriimino)-tris-benzoic acid tris(2-ethylhexyl ester), also: 2,4,6-tris-[anilino-(p-carbo-2′-ethyl-1′-hexyloxy)]-1,3,5-triazine (INCI: octyl triazone), which is marketed by BASF Aktiengesellschaft under the trade name UVINUL® T 150.

An advantageous broad-band filter in the context of the present invention is also 2,2′-methylene-bis-(6-(2H-benzotriazol-2-yl)-4-(1,1,3,3-tetramethylbutyl)-phenol) (INCI:bisoctyltriazole), which is obtainable under the trade name Tinosorb® M from CIBA-Chemikalien GmbH.

An advantageous broad-band filter in the context of the present invention is furthermore 2-(2H-benzotriazol-2-yl )-4-methyl-6-[2-methyl-3-[1,3,3,3-tetramethyl-1-[(tri-methylsilyl)oxy]disiloxanyl]propyl]-phenol (CAS no.: 155633-54-8) with the INCI name drometrizole trisiloxane.

The further UV filter substances can be oil-soluble. Advantageous oil-soluble filter substances are e.g.:

3-benzylidenecamphor derivatives, preferably 3-(4-methylbenzylidene)camphor, 3-benzylidenecamphor;

4-aminobenzoic acid derivatives, preferably 4-(dimethylamino)-benzoic acid (2-ethyl-hexyl)ester, 4-(dimethylamino)benzoic acid amyl ester;

derivatives of benzophenone, preferably 2-hydroxy-4-methoxybenzophenone, 2-hydroxy-4-methoxy-4′-methylbenzophenone, 2,2′-dihydroxy-4-methoxybenzophenone

and UV filters bonded to polymers.

A further light protection filter substance which is advantageously to be used according to the invention is ethyihexyl 2-cyano-3,3-diphenylacrylate (octocrylene), which is obtainable from BASF under the name Uvinul® N 539.

Particularly advantageous formulations in the context of the present invention. which are distinguished by a high or very high UV-A protection furthermore preferably comprise, in addition to the filter substance(s) according to the invention, further UV-A and/or broad-band filters, in particular dibenzoylmethane derivatives [for example 4-(tert-butyl)-4′-methoxydibenzoylmethane] and/or 2,4-bis-{[4-(2-ethyl-hexyloxy)-2-hydroxy]-phenyl}-6-(4-methoxyphenyl)-1,3,5-triazine, in each case individually or in any desired combinations with one another.

The list of UV filters mentioned which can be employed in the context of the present invention is of course not intended to be limiting.

The formulations according to the invention advantageously comprise the substances which absorb UV radiation in the UV-A and/or UV-B range in a total amount of e.g. 0.1 wt. % to 30 wt. %, preferably 0.5 to 20 wt. %, in particular 1.0 to 15.0 wt. %, in each case based on the total weight of the formulations, in order to provide cosmetic formulations which protect the hair or the skin from the entire range of ultraviolet radiation.

It may furthermore be of advantage, where appropriate, to incorporate film-forming agents into the cosmetic or dermatological formulations according to the invention, for example in order to improve the water-resistance of the formulations or to increase the UV protection performance (UV-A and/or UV-B boosting). Both water-soluble or dispersible and fat-soluble film-forming agents, in each case individually or in combination with one another, are suitable.

Advantageous water-soluble or dispersible film-forming agents are e.g. polyurethanes (e.g. the Avalure® types from Goodrich), dimethicone copolyol polyacrylate (Silsoft Surface® from Witco Organo Silicones Group), PVPNA (VA=vinyl acetate) copolymer (Luviscol VA 64 Powder from BASF) etc.

Advantageous fat-soluble film-forming agents are e.g. the film-forming agents from the group consisting of polymers based on polyvinylpyrrolidone (PVP)

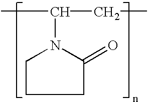

Copolymers of polyvinylpyrrolidone, for example PVP hexadecene copolymer and PVP eicosene copolymer, which are obtainable under the trade names Antaron V216 and Antaron V220 from GAF Chemicals Cooperation, and tricontayl PVP and many of the like are particularly preferred.

The following examples are intended to illustrate the present invention without limiting it. The numerical values in the examples denote percentages by weight, based on the total weight of the particular formulations.

### EXAMPLES

1. O/W sunscreen emulsions

| | 1 | 2 | 3 | 4 | 5 | 6 | 7 |
|---|---|---|---|---|---|---|---|
| Glycerol monostearate SE | 0.50 | 1.00 | 3.00 | | | 1.50 | |
| Glyceryl stearate citrate | 2.00 | | | 1.00 | 2.00 | | 2.50 |
| Stearic acid | | 3.00 | | 2.00 | | | |
| PEG-40 stearate | 0.50 | | | | | 2.00 | |
| Cetyl phosphate | | | | | 1.00 | | |
| Stearyl alcohol | | | 3.00 | | | 2.00 | 0.50 |
| Cetyl alcohol | 2.50 | 1.00 | | 1.50 | 0.50 | | 2.00 |
| Ethylhexyl | | | | 5.00 | 6.00 | | 8.00 |
| methoxycinnamate | | | | | | | |
| Bis-ethylhexyloxyphenol | | 1.50 | | 2.00 | 2.50 | | 2.50 |
| methoxyphenyl triazine | | | | | | | |
| Butyl | 1.00 | 3.00 | | 1.50 | 2.80 | 2.00 | 1.50 |
| methoxydibenzoylmethane | | | | | | | |
| Disodium phenyl | 2.50 | 0.50 | | 2.00 | 1.00 | 1.70 | 0.30 |
| dibenzimidazole | | | | | | | |
| tetrasulfonate | | | | | | | |
| Ethylhexyl triazone | 4.00 | | | 4.00 | 4.00 | 2.00 | |
| 4-Methylbenzylidene | 4.00 | 4.00 | | | 2.00 | 4.00 | 2.00 |
| camphor | | | | | | | |
| Octocrylene | | 4.00 | | | | | 2.50 |
| Diethylhexyl butamido | 1.00 | | | 2.00 | 1.00 | | |
| triazone | | | | | | | |
| Phenylbenzmidazole | 0.50 | | | 3.00 | | | |
| sulfonic acid | | | | | | | |
| Methylene bis-benzotriazolyl | 2.00 | | | 1.50 | 2.50 | | |
| tetramethylbutylphenol | | | | | | | |
| Benzophenone-3 | | | | 5.50 | | | |
| Isoamyl p-methoxycinnamate | | 1.50 | | | | | |
| Homosalate | | 2.00 | | | | | |
| Ethylhexyl salicylate | | | | | | | 5.00 |
| Drometrizole trisiloxane | | | | | | 1.00 | |
| Terephthalidene dicamphor | | 1.50 | | | 1.00 | 0.50 | |
| sulfonic acid | | | | | | | |
| Diethylhexyl 2,6-naphthalate | 3.50 | 4.80 | 7.00 | 9.50 | 6.70 | 5.50 | 8.00 |
| Repellent 3535 | 5.0 | 9.5 | 25 | 15.5 | 10 | | 18 |
| Bayrepel KBR 3023 | | | | | | 12 | |
| Titanium dioxide MT-100Z | 1.00 | 1.50 | | 3.00 | 2.00 | 2.00 | |
| Zinc oxide HP1 | | | | 1.00 | | 2.00 | 3.00 |
| C12-15 alkyl benzoate | | 2.50 | | | 4.00 | 7.00 | 5.00 |
| Dicaprylyl ether | | | 3.50 | | 2.00 | | |
| Butylene glycol | 5.00 | | | 6.00 | | | |
| dicaprylate/dicaprate | | | | | | | |
| Dicaprylyl carbonate | | | 6.00 | | | 2.00 | 2.00 |
| Dimethicone | | 0.50 | 1.00 | | 2.00 | | |
| Cyclomethicone | 2.00 | | | 0.50 | | | 0.50 |
| Shea butter | | 2.00 | | | | | 0.50 |
| PVP hexadecene copolymer | 0.50 | | | 0.50 | 1.00 | | 1.00 |
| Tricontanyl PVP | | 0.50 | 1.00 | | | | 1.00 |
| Glycerol | 3.00 | 7.50 | | 7.50 | 5.00 | | 2.50 |
| Xanthan gum | 0.15 | | 0.05 | | | | 0.30 |
| Sodium carbomer | | 0.20 | 0.10 | 0.20 | | | |
| Vitamin E acetate | 0.50 | | 0.25 | | 0.75 | | 1.00 |
| Polyurethane | | 0.50 | | 0.50 | | 1.00 | |
| Styrene/acrylate copolymer | 0.80 | | 3.00 | 1.50 | | | |
| DMDM hydantoin | | 0.60 | 0.40 | 0.20 | | | |
| Konkaben LMB ® | | | | 0.18 | 0.20 | 0.10 | 0.15 |
| Methyl paraben | 0.15 | | 0.25 | | 0.50 | | |
| Phenoxyethanol | 1.00 | 0.40 | | 0.40 | 0.50 | 0.40 | 0.60 |
| Ethanol | | 2.00 | 1.50 | | 3.00 | | 1.00 |
| Perfume | 0.20 | 0.20 | 0.20 | 0.20 | 0.20 | 0.20 | 0.20 |
| Water | to 100 | to 100 | to 100 | to 100 | to 100 | to 100 | to 100 |

2. Hydrodispersions

| | 1 | 2 | 3 | 4 | 5 |
|---|---|---|---|---|---|
| Ceteareth-20 | 1.00 | | | 0.5 | |
| Cetyl alcohol | | | 1.00 | | |
| Sodium carbomer | | 0.20 | | 0.30 | |
| Acrylates/C10-30 alkyl | 0.50 | | 0.40 | 0.10 | 0.10 |
| acrylate crosspolymer | | | | | |
| Xanthan gum | | 0.30 | 0.15 | | 0.50 |
| Ethylhexyl | | | | | 8.00 |
| methoxycinnamate | | | | | |
| Bis-ethylhexyloxyphenol | | 1.50 | | | 2.50 |
| methoxyphenyl triazine | | | | | |
| Butyl | 1.00 | 0.50 | 2.00 | | 2.50 |
| methoxydibenzoylmethane | | | | | |
| Disodium phenyl | 0.50 | 1.80 | 1.50 | | 3.00 |
| dibenzimidazole | | | | | |
| tetrasulfonate | | | | | |
| Ethylhexyl triazone | 4.00 | | 3.00 | | |
| 4-Methylbenzylidene | 4.00 | | | | 2.00 |
| camphor | | | | | |
| Octocrylene | | 4.00 | 3.90 | | 2.50 |
| Diethyhexyl butamido | 1.00 | | | | |
| triazone | | | | | |
| Phenylbenzmidazole | 0.50 | | | | |
| sulfonic acid | | | | | |
| Methylene bis- | 2.50 | 0.50 | | | 0.80 |
| benzotriazolyl | | | | | |
| tetramethylbuthylphenol | | | | | |
| Drometrizole trisiloxane | | | 1.00 | | 1.50 |
| Terephthalidene | | 0.50 | | | 1.00 |
| dicamphor | | | | | |
| sulfonic acid | | | | | |
| Diethylhexyl 2,6- | 4.50 | 8.00 | 7.20 | 5.50 | 9.80 |
| naphthalate | | | | | |
| Repellent 3535 | 5.0 | 12.0 | 5.0 | 22.5 | 18 |
| Bayrepel KBR 3023 | | | 15.5 | | |
| Titanium dioxide | 0.50 | | 2.00 | | 1.00 |
| MT-100TV | | | | | |
| Zinc oxide HP1 | | | 1.00 | | 3.00 |
| C12-15 alkyl benzoate | 2.00 | 2.50 | | | |
| Dicaprylyl ether | | 4.00 | | | |
| Butylene glycol | 4.00 | | 2.00 | 6.00 | |
| dicaprylate/dicaprate | | | | | |
| Dicaprylyl carbonate | | 2.00 | 6.00 | | |
| Dimethicone | | 0.50 | 1.00 | | |
| Phenyltrimethicone | 2.00 | | | 0.50 | 2.00 |
| Shea butter | | 2.00 | | | |
| PVP hexadecene | 0.50 | | | 0.50 | 1.00 |
| copolymer | | | | | |
| Tricontanyl PVP | 0.50 | | 1.00 | | |
| Ethylhexylglycerol | | | 1.00 | | 0.50 |
| Glycerol | 3.00 | 7.50 | | 7.50 | 2.50 |
| Glycine soya | | | 1.50 | | |
| Vitamin E acetate | 0.50 | | 0.25 | | 1.00 |
| Polyurethane | | 0.60 | 1.50 | 1.00 | |
| Styrene/acrylate | | 2.50 | 0.50 | | 2.00 |
| copolymer | | | | | |
| DMDM hydantoin | | 0.60 | 0.40 | 0.20 | |
| Konkaben LMB ® | 0.20 | | | | 0.15 |
| Methyl paraben | 0.50 | | 0.25 | 0.15 | |
| Phenoxyethanol | 0.50 | 0.40 | | 1.00 | 0.60 |
| Ethanol | 3.00 | 2.00 | 1.50 | | 1.00 |
| Perfume | 0.20 | 0.20 | 0.20 | 0.20 | 0.20 |
| Water | to | to 100 | to 100 | to 100 | to 100 |
| | 100 | | | | |

3. W/O sunscreen emulsions

| | 1 | 2 | 3 | 4 | 5 |
|---|---|---|---|---|---|
| Cetyldimethicone copolyol | | 2.50 | | 4.00 | |
| Polyglyceryl 2- | 5.00 | | | | 4.50 |
| dipolyhydroxystearate | | | | | |
| PEG-30 | | | 5.00 | | |
| dipolyhydroxystearate | | | | | |
| Ethylhexyl | | 8.00 | 3.0 | 5.00 | 4.00 |
| methoxycinnamate | | | | | |
| Bis-ethylhexyloxyphenol | 2.00 | 2.50 | | 2.00 | 2.50 |
| methoxyphenyl | | | | | |
| triazine | | | | | |
| Butyl | 0.50 | 3.00 | | 1.00 | 0.70 |
| methoxydibenzoylmethane | | | | | |
| Disodium phenyl | 0.50 | 1.00 | | 2.00 | 2.60 |
| dibenzimidazole | | | | | |
| tetrasulfonate | | | | | |
| Ethylhexyl triazone | | | | 4.00 | |
| 4-Methylbenzylidene | | 2.00 | | 4.00 | 2.00 |
| camphor | | | | | |
| Octocrylene | 0.90 | 2.50 | 3.90 | | 2.50 |
| Diethyhexyl butamido | 1.00 | | | 2.00 | |
| triazone | | | | | |
| Phenylbenzmidazole | 0.50 | | | 3.00 | 2.00 |
| sulfonic acid | | | | | |
| Methylene bis- | | | | 0.50 | |
| benzotriazolyl | | | | | |
| tetramethylbutylphenol | | | | | |
| Drometrizole trisiloxane | | 1.00 | | | 1.50 |
| Terephthalidene | | | 1.00 | | 0.50 |
| dicamphor | | | | | |
| sulfonic acid | | | | | |
| Diethylhexyl 2,6- | 7.50 | 5.50 | 3.50 | 8.80 | 9.70 |
| naphthalate | | | | | |
| Repellent 3535 | 8.0 | 12.5 | | 20.5 | 25 |
| Bayrepel KBR 3023 | | | 6.0 | | |
| Titanium dioxide T805 | | 2.00 | 1.50 | | 3.00 |
| Zinc oxide NDM | 1.00 | | 3.00 | | 2.00 |
| Mineral oil | | | 10.0 | | 8.00 |
| C12-15 alkyl benzoate | | | | 9.00 | |
| Dicaprylyl ether | 10.00 | | | | 7.00 |
| Butylene glycol | | | 2.00 | 8.00 | 4.00 |
| dicaprylate/dicaprate | | | | | |
| Dicaprylyl carbonate | 5.00 | | 6.00 | | |
| Dimethicone | | 4.00 | 1.00 | 5.00 | |
| Cyclomethicone | 2.00 | 25.00 | | | 2.00 |
| Shea butter | | | 3.00 | | |
| PVP hexadecene | 0.50 | | | 0.50 | 1.00 |
| copolymer | | | | | |
| Tricontanyl PVP | | | 0.50 | 1.00 | 0.50 |
| Ethylhexylglycerol | | 0.30 | 1.00 | | 0.50 |
| Glycerol | 3.00 | 7.50 | | 7.50 | 2.50 |
| Glycine soya | | 1.00 | 1.50 | | |
| MgSO₄ | 1.00 | 0.50 | | 0.50 | |
| MgCl₂ | | | 1.00 | | 0.70 |
| Vitamin E acetate | 0.50 | | 0.25 | | 1.00 |
| Styrene/acrylate | 0.50 | | | 2.50 | |
| copolymer | | | | | |
| Polyurethane | | 0.50 | | 1.50 | |
| DMDM hydantoin | | 0.60 | 0.40 | 0.20 | |
| Methyl paraben | 0.50 | | 0.25 | 0.15 | |
| Phenoxyethanol | 0.50 | 0.40 | | 1.00 | 0.60 |
| Ethanol | 3.00 | | 1.50 | | 1.00 |
| Perfume | 0.20 | 0.20 | 0.20 | 0.20 | 0.20 |
| Water | to | to 100 | to 100 | to 100 | to 100 |
| | 100 | | | | |

4. Solid-stabilized emulsions

| | 1 | 2 | 3 | 4 | 5 |
|---|---|---|---|---|---|
| Mineral oil | | | 16.0 | 16.0 | |
| Octyldodecanol | 9.0 | 9.0 | 5.0 | | |
| Caprylic/capric triglyceride | 9.0 | 9.0 | 6.0 | | |
| C12-15-alkyl benzoate | | | | 5.0 | 8.0 |
| Butylene glycol | | | | | 8.0 |
| dicaprylate/dicaprate | | | | | |
| Dicaprylyl ether | 9.0 | | | 4.0 | |
| Dicaprylyl carbonate | | 9.0 | | | |
| Hydroxyoctacosanyl | 2.0 | 2.0 | 2.0 | 2.0 | 1.5 |
| hydroxystearate | | | | | |
| Disteardimonium hectorite | 1.0 | 0.75 | 0.5 | 0.5 | 0.25 |
| Cera microcristallina + paraffinum | | | | | 5.0 |
| liquidum | | | | | |
| Hydroxypropyl methylcellulose | | | | | 0.05 |
| Dimethicone | | | | | 3.0 |
| Butyl | 2.00 | 0.50 | | 1.50 | 0.50 |
| methoxydibenzoylmethane | | | | | |
| Ethylhexyl methoxycinnamate | | | | | 3.0 |
| 4-Methylbenzylidene camphor | | | | | 4.0 |
| Diethylhexyl butamido triazone | | | | | 4.0 |
| Methylene bis-benzotriazolyl | 0.50 | | | 2.0 | |
| tetramethylbutylphenol | | | | | |
| Drometrizole trisiloxane | | 0.50 | | 1.00 | |
| Terephthalidene dicamphor | | 1.00 | | | 1.50 |
| sulfonic acid | | | | | |
| Disodium phenyl | 2.50 | 2.00 | | 1.50 | 0.50 |
| dibenzimidazole tetrasulfonate | | | | | |
| Titanium dioxide + alumina + | | 2.0 | 4.0 | 2.0 | 4.0 |
| simethicone + aqua | | | | | |
| Titanium dioxide + trimethoxycaprylylsilane | | | | | 3.0 |
| Zinc oxide HP1 | | | | 6.0 | |
| Silica dimethyl silylate | | | 1.0 | | |
| Boron nitride | 2.0 | | | | |
| Starch/sodium metaphosphate | | 0.5 | | | |
| polymer | | | | | |
| Diethylhexyl 2,6-naphthalate | 4.5 | 7.00 | 8.50 | 3.00 | 6.0 |
| Repellent 3535 | 7.5 | 12 | 15 | 25 | 8.0 |
| Bayrepel KBR 3023 | | | 2.0 | | |
| Tapioca starch | | | | 1.0 | |
| Polyurethane | 0.20 | | 1.50 | 0.50 | |
| Styrene/acrylate copolymer | | 2.00 | | | 3.00 |
| Sodium chloride | 1.0 | 1.0 | 1.0 | 1.0 | 1.0 |
| Glycerol | 5.0 | 10.0 | 3.0 | 6.0 | 10.0 |
| Trisodium EDTA | | 1.0 | | 1.0 | |
| Methyl paraben | 0.21 | | | | 0.2 |
| Propyl paraben | 0.07 | | | | |
| Phenoxyethanol | 0.5 | | 0.4 | 0.4 | 0.5 |
| Hexamidine diisethionate | | | | | 0.08 |
| Diazolidinyl urea | | | 0.28 | 0.28 | |
| Alcohol | | | | 2.5 | |
| Perfume | q.s. | q.s. | q.s. | q.s. | q.s. |
| Water | to 100 | to 100 | to 100 | to 100 | to 100 |
| | 6 | 7 | 8 | 9 | 10 |
| Mineral oil | | | | | 16.0 |
| Octyldodecanol | 6.0 | | 7.5 | 7.5 | 5.0 |
| Caprylic/capric triglyceride | | | | | 6.0 |
| C12-15-alkyl benzoate | 7.0 | 8.0 | 7.5 | 7.5 | |
| Butylene glycol | 4.0 | 8.0 | | | |
| dicaprylate/dicaprate | | | | | |
| Dicaprylyl ether | | 8.0 | 7.5 | 7.5 | |
| Dicaprylyl carbonate | 4.0 | | | | |
| Hydroxyoctacosanyl | 2.0 | 2.0 | 2.0 | 2.0 | 1.5 |
| hydroxystearate | | | | | |
| PVP/hexadecene copolymer | | | | 1.0 | 0.7 |
| Disteardimonium hectorite | 1.0 | 1.0 | 1.0 | 0.5 | 1.0 |
| Dimethicone | | 2.0 | | | |
| Cyclomethicone | | | | 2.0 | |
| Ethylhexyl methoxycinnamate | 5.0 | | 5.0 | | |
| Butyl | 3.00 | 2.0 | 0.50 | 1.80 | 1.0 |
| methoxydibenzoylmethane | | | | | |
| 4-Methylbenzylidene camphor | | 4.0 | | | 2.0 |
| Ethylhexyltriazone | 2.0 | 2.0 | | | 1.0 |
| Methylene bis-benzotriazolyl | | 3.00 | | 2.50 | |
| tetramethylbuthylphenol | | | | | |
| Bis-ethylhexyloxyphenol methoxyphenyl | 2.5 | | 2.5 | | |
| triazine | | | | | |
| Titanium dioxide + alumina + | 1.5 | 2.0 | 4.0 | 0.5 | 1.5 |
| simethicone + aqua | | | | | |
| Titanium dioxide + trimethoxycaprylylsilane | | | 2.0 | | |
| Zinc oxide | | | 2.0 | | |
| Phenylbenzimidazole sulfonic | 2.0 | | | | |
| acid | | | | | |
| Disodium phenyl | 2.50 | 1.00 | 0.60 | 1.50 | 3.00 |
| dibenzimidazole tetrasulfonate | | | | | |
| Boron nitride | | | | | 0.5 |
| Starch/sodium metaphosphate | 0.5 | | 1.5 | | |
| polymer | | | | | |
| Corn starch, modified | | 1.0 | | | |
| Acrylate copolymer | | | | 0.25 | |
| Talc | | | | 2.0 | |
| Sodium chloride | 1.0 | 1.0 | 1.0 | | |
| Diethylhexyl 2,6-naphthalate | 4.00 | 6.50 | 7.50 | 9.50 | 5.00 |
| Repellent 3535 | 6.0 | 15 | 8.0 | 22.5 | 20 |
| Bayrepel KBR 3023 | 12 | | | | |
| Polyurethane | | 0.50 | 1.50 | | 0.40 |
| Styrene/acrylate copolymer | 1.50 | | | | 3.00 |
| Magnesium sulfate | | | | | 0.70 |
| Sodium hydroxide solution | 0.5 | 0.5 | | | |
| 45% | | | | | |
| Glycerol | 5.0 | 7.5 | 5.0 | 10.0 | 3.0 |
| Trisodium EDTA | | 1.0 | 1.0 | | 1.0 |
| Propylene carbonate | 0.33 | 0.33 | 0.33 | | 0.33 |
| Methyl paraben | 0.21 | 0.21 | 0.2 | 0.2 | 0.21 |
| Propyl paraben | 0.07 | 0.07 | | | 0.07 |
| Phenoxyethanol | 0.5 | 0.5 | 0.5 | 0.5 | 0.5 |
| Hexamidine diisethionate | | | 0.08 | 0.08 | |
| Alcohol | | 5.0 | | | |
| Perfume | q.s. | q.s. | q.s. | q.s. | q.s. |
| Water | to 100 | to 100 | to 100 | to 100 | to 100 |

That which is claimed:

1. A cosmetic or dermatological formulation comprising at least one repellent active compound and at least one dialkyl naphthalate having the structural formula 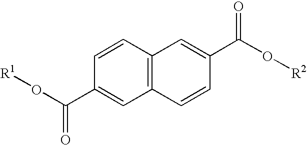
wherein R¹ and R² independently of one another are selected from the group consisting of branched and unbranched alkyl groups having 6 to 24 carbon atoms.

2. The formulation as claimed in claim 1, wherein at least one of R¹ and R² is a branched alkyl group having 6 to 10 carbon atoms.

3. The formulation as claimed in claim 1, wherein R¹ and R² are branched alkyl groups having 6 to 10 carbon atoms.

4. The formulation as claimed in claim 1, wherein the at least one dialkyl naphthalate comprises diethylhexyl naphthalate.

5. The formulation as claimed in claim 1, wherein the at least one dialkyl naphthalate is present in amount of 0.001 to 20 weight % based on the total weight of the formulation.

6. The formulation as claimed in claim 5, wherein the at least one dialkyl naphthalate is present in an amount of 0.01 to 15 weight % based on the total weight of the formulation.

7. The formulation as claimed in claim 5, wherein the at least one dialkyl naphthalate is present in an amount of 3 to 10 weight % based on the total weight of the formulation.

8. The formulation as claimed in claim 1, wherein the at least one repellant active compound is selected from the group consisting of N,N-diethyl-3-methylbenzamide, 3-(N-n-butyl-N-acetyl-amino)-propionic acid ethyl ester, dimethyl phthalate, butopyronoxyl, 2,3′,4,5-bis-(2-butylene)-tetrahydro-2-furaldehyde, N,N-caprylic acid diethylamide, α-chloro-N,N-diethyl-benzamide in a mixture with N,N-diethyl-benzamide, dimethyl carbate, di-n-propyl isocinchomeronate, 2-ethylhexane-1,2-diol, N-octyl-bi-cyclo-heptanedicarboximide, piperonyl butoxide, and mixtures thereof.

9. The formulation as claimed in claim 1, wherein the at least one repellant active compound is present in an amount of 1 to 70 weight % based on the total weight of the formulation.

10. The formulation as claimed in claim 9, wherein the at least one repellant active compound is present in an amount of 1 to 50 weight % based on the total weight of the formulation.

11. The formulation as claimed in claim 1, further comprising at least one UV filter substance.

12. The formulation as claimed in claim 11, wherein the at least one UV filter substance is selected from the group consisting of triazines, benzotriazoles, organic pigments, inorganic pigments, and mixtures thereof.

13. The formulation as claimed in claim 1, further comprising at least one UV-A filter substance or broad-band filter substance.

14. The formulation as claimed in claim 13, wherein the at least one UV-A filter substance or broad-band filter substance includes at least one dibenzoylmethane derivative.

15. The formulation as claimed in claim 14, wherein the at least one dibenzoylmethane derivative is selected from the group consisting of 4-(tert-butyl)-4′-methoxydibenzoylmethane, 2,4-bis-{[4-(2-ethyl-hexyloxy)-2-hydroxy]-phenyl}-6-(4-meth-oxyphenyl)-1,3,5-triazine, and mixtures thereof.

16. A method for increasing the stability of a cosmetic or dermatological formulation having at least one repellant active compound comprising adding to the formulation at least one dialkyl naphthalate having the structural formula 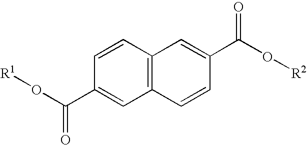
wherein R¹ and R² independently of one another are selected from the group consisting of branched and unbranched alkyl groups having 6 to 24 carbon atoms.
